(19) United States
(12) Patent Application Publication
(10) Pub. No.: US 2020/0189142 A1
(43) Pub. Date: Jun. 18, 2020

(54) CONTROL CIRCUIT OF BANANA SLICE FRYING MACHINE AND CONTROL METHOD THEREFOR

(71) Applicant: WUYI University, Guangdong (CN)

(72) Inventors: Shufen LIANG, Guangdong (CN); Hui HUANG, Guangdong (CN); Huimin XIE, Guangdong (CN); Yankun WEI, Guangdong (CN); Yunrui DONG, Guangdong (CN); Manying HU, Guangdong (CN); Dongliang XIAN, Guangdong (CN); Zining XIE, Guangdong (CN); Shufeng HUANG, Guangdong (CN); Qiaowei LIANG, Guangdong (CN)

(73) Assignee: WUYI University

(21) Appl. No.: 16/680,166

(22) Filed: Nov. 11, 2019

(30) Foreign Application Priority Data
Dec. 18, 2018 (CN) 201811553483.2

(51) Int. Cl. B26D 5/08; A47J 37/10; F24C 7/08; A47J 43/07

(52) U.S. Cl. CPC B26D 5/086; A47J 37/108; A47J 2043/0733; A47J 43/07; F24C 7/087

(57) ABSTRACT

Disclosed are a control circuit of a banana slice frying machine and a control method therefor. The control circuit comprises a MCU, a material cutting module and a processing module, wherein the material cutting module and the processing module are both connected with the MCU, the material cutting module comprises a slicer motor and a range sensor, and the processing module comprises an X-axis driving motor, a Y-axis driving motor, a Z-axis motor and a temperature control module. Signals from the range sensor and the temperature control module are received by the MCU, then feedback information is transmitted to a working element, and the MCU drives the slicer motor to perform automatic cutting and control a heating temperature of an oil pan to realize a full automatic working process from cutting to frying, so that a conventional semi-automatic working manner is abandoned, and result in great convenience.

### TECHNICAL FIELD

The present disclosure relates to the field of food processing equipment, and more particularly, to a control circuit of a banana slice frying machine and a control method therefor.

### BACKGROUND

Banana is an important food all over the world, especially in some countries and regions in South America and southern Africa, and banana is a main starch food for local people. Banana is called “the happy fruit” in Europe, which not only is rich in nutrition, but also contains more than ten times of potassium than that contained in other fruits.

At present, a series of products of banana are very popular in all major commodity markets. In recent years, fried banana has become an indispensable snack in high streets and back lanes. Currently, fried banana slices are mainly produced by a large-scale machine in an assembly-line manner, while a small-scale banana frying machine used by ordinary consumers in daily life is mostly in a semi-automatic frying manner, which cannot completely and automatically complete functions of cutting and frying.

### SUMMARY

The present disclosure is intended to solve one of the technical problems above in the related art to some extent. Therefore, the present disclosure provides a control circuit of a banana slice frying machine and a control method therefor.

The technical solutions used in the present disclosure to solve the technical problems thereof are as follows.

A control circuit of a banana slice frying machine, comprising:

a MCU;

a material cutting module including a slicer motor configured to control a feed direction of a slicer, and a range sensor arranged in a conveying channel is configured to sense whether a banana exists in the conveying channel and transmit information to the MCU; and

a processing module including an X-axis driving motor configured to control a pipeline to move in an X-direction, a Y-axis driving motor configured to control the pipeline to move in a Y-direction, a Z-axis motor configured to control a press mold provided at one side of the pipeline to move in a Z-direction and squeeze the banana in an oil pan, and a temperature control module arranged in the oil pan is configured to test a temperature of oil in the oil pan and transmit information to the MCU;

wherein the material cutting module and the processing module are both connected with the MCU;

the MCU is configured to: receive information from the range sensor and control forward and reverse rotation of the slicer motor; receive temperature data from the temperature control module and control the oil pan to adjust an oil temperature; and control forward and reverse rotation of the X-axis driving motor, the Y-axis driving motor and the Z-axis motor;

the conveying channel and the oil pan is configured to directly send a banana slice into the oil pan through the pipeline.

As an improvement to the technical solution above, the control circuit of a banana slice frying machine further comprises a material conveying module, wherein the material conveying module is connected with the MCU, the material conveying module comprises a conveying motor, and the MCU controls the conveying motor to drive a crawler belt to convey the banana.

As an improvement to the technical solution above, the temperature control module comprises a temperature sensor, and the temperature sensor is arranged in the oil pan.

Further, the control circuit of a banana slice frying machine further comprises a touch screen and a data conversion module, wherein the data conversion module is configured to perform data conversion between the touch screen and the MCU.

Further, the material conveying module further comprises a weight sensor, the weight sensor is configured to transmit a signal to the MCU, and the MCU opens or closes a door of a feed inlet according to the signal of the weight sensor.

A control method for the control circuit of a banana slice frying machine comprises the following steps of:

A. setting a distance between the range sensor and the slicer as a banana length needed for a raw material, transmitting a signal from the range sensor to the MCU, and controlling the slicer motor by the MCU to cut the banana;

B. feeding the cut banana into the oil pan through the pipeline;

C. driving, by the MCU, the X-axis driving motor and the Y-axis driving motor to rotate forwardly or reversely, and putting a plurality of banana slices into the oil pan;

D. driving, by the MCU, the Z-axis driving motor to drive the press mold to squeeze the banana slice in frying; and

E. setting a frying temperature in the MCU, transmitting a real-time temperature to the MCU through the temperature control module, and controlling a heating temperature of the oil pan by the MCU.

The present disclosure has the beneficial effects that: as the improvement to the technical solution above, the control circuit of a banana slice frying machine comprises the MCU, the material cutting module and the processing module, wherein the material cutting module and the processing module are both connected with the MCU, the material cutting module comprises the slicer motor and the range sensor, and the processing module comprises the X-axis driving motor, the Y-axis driving motor, the Z-axis motor and the temperature control module. Signals from the range sensor and the temperature control module are received by the MCU, then feedback information is transmitted to a working element, and the MCU drives the slicer motor to perform automatic cutting and control the heating temperature of the oil pan to realize a full automatic working process from cutting to frying, so that a conventional semi-automatic working manner is abandoned, and result in great convenience.

### BRIEF DESCRIPTION OF THE DRAWINGS

The present disclosure is further described hereinafter with reference to the drawings and the embodiments.

FIG. 1 is a structure diagram of the present disclosure.

### DETAILED DESCRIPTION

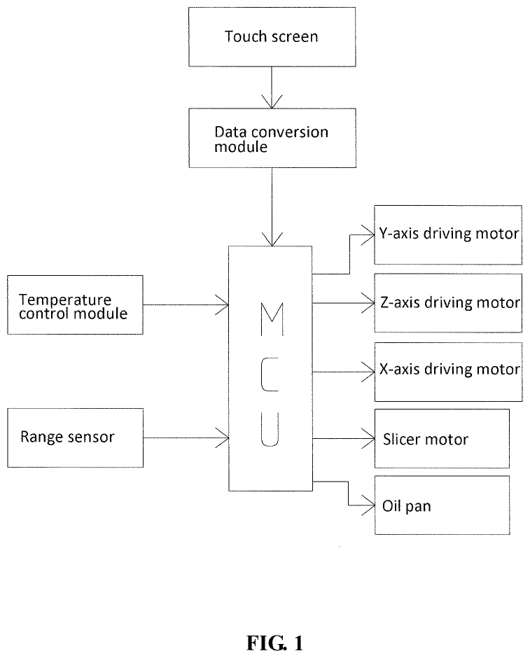

Referring to FIG. 1, a control circuit of a banana slice frying machine of the present disclosure comprises a MCU, a material cutting module and a processing module, wherein the material cutting module and the processing module are both connected with the MCU, the material cutting module comprises a slicer motor and a range sensor, and the processing module comprises an X-axis driving motor, a Y-axis driving motor, a Z-axis motor and a temperature control module.

The range sensor is configured to sense whether a banana exists in a conveying channel and transmits information to the MCU.

The temperature control module is configured to test a temperature of oil in an oil pan and transmit information to the MCU.

The MCU is configured to: receive information from the range sensor and control forward and reverse rotation of the slicer motor; receive temperature data from the temperature control module and controls the oil pan to adjust an oil temperature; and control forward and reverse rotation of the X-axis driving motor, the Y-axis driving motor and the Z-axis motor.

The temperature control module is arranged in the oil pan, the range sensor is arranged in the conveying channel, the conveying channel and the oil pan is configured to directly send a banana slice into the oil pan through a pipeline, and a press mold is provided at one side of the pipeline.

The X-axis is configured to drive motor controls the pipeline to move in an X-direction.

The Y-axis is configured to drive motor controls the pipeline to move in a Y-direction.

The Z-axis motor is configured to control the press mold to move in a Z-direction and squeeze the banana in the oil pan.

The slicer motor is configured to control a feed direction of a slicer.

During operation, signals from the range sensor and the temperature control module are received by the MCU, then feedback information is transmitted to a working element, and the MCU drives the slicer motor to perform automatic cutting and control the heating temperature of the oil pan to realize a full automatic working process from cutting to frying, so that a conventional semi-automatic working manner is abandoned, and the convenience is greatly improved.

In an embodiment, in order to improve a degree of automation, the banana frying machine is internally provided with a material storage box for placing the banana, and the banana is conveyed to a processing part by a crawler belt. Therefore, the banana frying machine further comprises a material conveying module, wherein the material conveying module is connected with the MCU, the material conveying module comprises a conveying motor, and the MCU controls the conveying motor to drive the crawler belt to convey the banana. A user transmits a signal to the MCU to produce fried banana slices, and the MCU receives the signal and outputs a control signal to drive the conveying motor to start and drive the banana to enter the processing part.

As an improvement of the embodiment above, the control circuit of a banana slice frying machine further comprises a touch screen and a data conversion module, wherein the data conversion module is configured to perform data conversion between the touch screen and the MCU. Through human-computer interaction between the touch screen and the user, a parameter set in the MCU can be modified in real time, or the banana slice frying machine can be controlled to be started or shut down. As an implementation of the embodiment above, when the user operates a human-machine interface of the touch screen, such as code scanning for payment, the data conversion module transmits the information to the MCU, and the MCU drives the crawler belt to convey the banana to a discharge port.

In an embodiment, in order to meet the requirement of automatic selling, a door is arranged at the discharge port of the material conveying module of the banana frying machine, and when payment processing is required, the banana is manually taken out of the discharge port and put into the conveying channel for cutting, and subsequent frying processing is continued. Therefore, the material conveying module further comprises a weight sensor, the weight sensor is configured to transmit a signal to the MCU, and the MCU opens or closes a door of a feed inlet according to the signal of the weight sensor. The weight sensor sends a signal to the MCU to identify whether the banana exists in the discharge port, so that the MCU drives the door to be opened or closed to prevent malicious damage.

Preferably, the temperature control module comprises a temperature sensor, and the temperature sensor is arranged in the oil pan. The temperature sensor monitors the oil temperature in real time and transmits temperature data to the MCU, so that the MCU can control the heating temperature of the oil pan in real time and ensure that the oil temperature in the oil pan is within a set value range.

A control method for the control circuit of a banana slice frying machine comprises the following steps of:

A. setting a distance between the range sensor and the slicer as a banana length needed for a raw material, transmitting a signal from the range sensor to the MCU, and controlling the slicer motor by the MCU to cut the banana;

B. feeding the cut banana into the oil pan through the pipeline;

C. driving, by the MCU, the X-axis driving motor and the Y-axis driving motor to rotate forwardly or reversely, and putting a plurality of banana slices into the oil pan;

D. driving, by the MCU, the Z-axis driving motor to drive the press mold to squeeze the banana slice in frying; and

E. setting a frying temperature in the MCU, transmitting a real-time temperature to the MCU through the temperature control module, and controlling a heating temperature of the oil pan by the MCU.

The specific structure and size data above describe the preferred embodiments of the present disclosure in detail, but the present disclosure is not limited to the embodiments, those skilled in the art may make various equal deformations or replacements without deviating from the spirit of the present disclosure, and these equal deformations or replacements all fall within the scope limited by the claims of the application.

What is claimed is:

1. A control circuit of a banana slice frying machine, comprising:
a MCU;
a material cutting module including a slicer motor configured to control a feed direction of a slicer, and a range sensor arranged in a conveying channel is configured to sense whether a banana exists in the conveying channel and transmit information to the MCU; and
a processing module including an X-axis driving motor configured to control a pipeline to move in an X-direction, a Y-axis driving motor configured to control the pipeline to move in a Y-direction, a Z-axis motor configured to control a press mold provided at one side of the pipeline to move in a Z-direction and squeeze the banana in an oil pan, and a temperature control module arranged in the oil pan is configured to test a temperature of oil in the oil pan and transmit information to the MCU;
wherein the material cutting module and the processing module are both connected with the MCU;
the MCU is configured to: receive information from the range sensor and control forward and reverse rotation of the slicer motor; receive temperature data from the temperature control module and control the oil pan to adjust an oil temperature; and control forward and reverse rotation of the X-axis driving motor, the Y-axis driving motor and the Z-axis motor;
the conveying channel and the oil pan is configured to directly send a banana slice into the oil pan through the pipeline.

2. The control circuit of claim 1, further comprising a material conveying module including a conveying motor, wherein the material conveying module is connected with the MCU, and the MCU is configured to control the conveying motor to drive a crawler belt to convey the banana.

3. The control circuit of claim 1, wherein the temperature control module comprises a temperature sensor arranged in the oil pan.

4. The control circuit of claim 1, further comprising a touch screen and a data conversion module configured to perform data conversion between the touch screen and the MCU.

5. The control circuit of claim 2, wherein the material conveying module further comprises a weight sensor configured to transmit a signal to the MCU, and the MCU is configured to open or close a door of a feed inlet according to the signal of the weight sensor.

6. A control method for the control circuit of claim 1, comprising:
setting a distance between the range sensor and the slicer as a banana length needed for a raw material, transmitting a signal from the range sensor to the MCU, and controlling the slicer motor by the MCU to cut the banana;
feeding the cut banana into the oil pan through the pipeline;
driving, by the MCU, the X-axis driving motor and the Y-axis driving motor to rotate forwardly or reversely, and putting a plurality of banana slices into the oil pan;
driving, by the MCU, the Z-axis driving motor to drive the press mold to squeeze the banana slice in frying; and
setting a frying temperature in the MCU, transmitting a real-time temperature to the MCU through the temperature control module, and controlling a heating temperature of the oil pan by the MCU.

7. A control method for the control circuit of claim 2, comprising:
setting a distance between the range sensor and the slicer as a banana length needed for a raw material, transmitting a signal from the range sensor to the MCU, and controlling the slicer motor by the MCU to cut the banana;
feeding the cut banana into the oil pan through the pipeline;
driving, by the MCU, the X-axis driving motor and the Y-axis driving motor to rotate forwardly or reversely, and putting a plurality of banana slices into the oil pan;
driving, by the MCU, the Z-axis driving motor to drive the press mold to squeeze the banana slice in frying; and
setting a frying temperature in the MCU, transmitting a real-time temperature to the MCU through the temperature control module, and controlling a heating temperature of the oil pan by the MCU.

8. A control method for the control circuit of claim 3, comprising:
setting a distance between the range sensor and the slicer as a banana length needed for a raw material, transmitting a signal from the range sensor to the MCU, and controlling the slicer motor by the MCU to cut the banana;
feeding the cut banana into the oil pan through the pipeline;
driving, by the MCU, the X-axis driving motor and the Y-axis driving motor to rotate forwardly or reversely, and putting a plurality of banana slices into the oil pan;
driving, by the MCU, the Z-axis driving motor to drive the press mold to squeeze the banana slice in frying; and
setting a frying temperature in the MCU, transmitting a real-time temperature to the MCU through the temperature control module, and controlling a heating temperature of the oil pan by the MCU.

9. A control method for the control circuit of claim 4, comprising:
setting a distance between the range sensor and the slicer as a banana length needed for a raw material, transmitting a signal from the range sensor to the MCU, and controlling the slicer motor by the MCU to cut the banana;
feeding the cut banana into the oil pan through the pipeline;
driving, by the MCU, the X-axis driving motor and the Y-axis driving motor to rotate forwardly or reversely, and putting a plurality of banana slices into the oil pan;
driving, by the MCU, the Z-axis driving motor to drive the press mold to squeeze the banana slice in frying; and
setting a frying temperature in the MCU, transmitting a real-time temperature to the MCU through the temperature control module, and controlling a heating temperature of the oil pan by the MCU.

10. A control method for the control circuit of claim 5, comprising:
setting a distance between the range sensor and the slicer as a banana length needed for a raw material, transmitting a signal from the range sensor to the MCU, and controlling the slicer motor by the MCU to cut the banana;
feeding the cut banana into the oil pan through the pipeline;
driving, by the MCU, the X-axis driving motor and the Y-axis driving motor to rotate forwardly or reversely, and putting a plurality of banana slices into the oil pan;
driving, by the MCU, the Z-axis driving motor to drive the press mold to squeeze the banana slice in frying; and
setting a frying temperature in the MCU, transmitting a real-time temperature to the MCU through the temperature control module, and controlling a heating temperature of the oil pan by the MCU.
